(19) United States
(12) Patent Application Publication
(10) Pub. No.: US 2010/0227605 A1
(43) Pub. Date: Sep. 9, 2010

(54) Control Of A Remote Mobile Device

(76) Inventor: Aymon Patrick Fournier, Bethesda, MD (US)

Correspondence Address: Ashok Tankha, 36 Greenleigh Drive, Sewell, NJ, 08080, US

(21) Appl. No.: 12/719,874

(22) Filed: Mar. 9, 2010

Related U.S. Application Data
(60) Provisional application No. 61/158,401, filed on Mar. 9, 2009.

(51) Int. Cl. H04W 4/00; G05B 19/00

(52) U.S. Cl. 455/419; 340/5.8

(57) ABSTRACT

A method and system for establishing communication with a remote mobile device and inducing one or more functionalities on the remote mobile device are provided. A client application is provided on the remote mobile device. An authentication code with commands and parameters is sent to the client application using, for example, a short message service message. The client application receives the authentication code with the commands and parameters. The client application compares the authentication code with a predefined code stored on the remote mobile device to find a match. The client application executes the commands on finding the match. The commands comprise instructions to induce functionalities on the remote mobile device. The functionalities, for example, comprise performing a playback of a media file and simultaneously performing a recording operation by the remote mobile device, retrieving information, modifying settings, forwarding messages and information, and invoking operations on the remote mobile device.

### CROSS REFERENCE TO RELATED APPLICATIONS

This application claims the benefit of provisional patent application No. 61/158,401 titled “Control Of A Remote Mobile Device”, filed on Mar. 9, 2009 in the United States Patent and Trademark Office.

The specification of the above referenced patent application is incorporated herein by reference in its entirety.

### BACKGROUND

This invention, in general, relates to a remote communication. More particularly, this invention relates to establishing communication with a remote mobile device that may have been misplaced, stolen or misused, and inducing one or more functionalities on the remote mobile device.

Mobile operating systems (OSs) developed in recent years, for example, the Android operating system of Google Inc. allow open access to their code libraries so that developers can create their own applications using the software development kit (SDK) of the OS. An SDK is essentially a code library that provides methods and functions that can interact with various hardware and software features of the mobile device or the operating system of the mobile device. Developers leverage the existing software/hardware platform of the mobile device to enhance functionality and usability of these mobile devices. Nevertheless, the potential for developing a variety of applications on different areas of functionality and usability of the mobile device still remains. For example, convenient, extendable, and constantly evolving application areas that allow remote manipulation of the mobile device for mobile device tracking, remotely monitoring messages and calls, and remote control for amusement purposes still remain untapped in the application market.

Hence, there is a need for a method and system that remotely controls a mobile device for remotely inducing different functionalities on the mobile device.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated need for establishing communication with a remote mobile device and inducing one or more functionalities on the remote mobile device. A client application is provided on the remote mobile device. An authentication code in combination with one or more commands and parameters is sent to the client application on the remote mobile device using, for example, a short message service (SMS) message. The client application receives the authentication code with the commands and parameters. The client application compares the received authentication code with a predefined code stored on the remote mobile device to find a match. The client application executes the commands on finding the match. The commands comprise instructions to induce functionalities on the remote mobile device. The client application induces the functionalities on the remote mobile device on execution of the commands. The functionalities comprise, for example, performing a playback of a media file and simultaneously performing a recording operation by the remote mobile device, retrieving information from the remote mobile device, modifying settings of the remote mobile device, and invoking operations on the remote mobile device.

The client application retrieves information, for example, the geographical location of the remote mobile device, call logs, media files stored on the remote mobile device, and information of contacts stored on the remote mobile device. The client application sends the retrieved information to a controlling communication device or one or more second remote mobile devices based on the commands. The functionalities of modifying settings of the remote mobile device comprise, for example, enabling or disabling a global positioning system (GPS) on the remote mobile device, adjusting volume of a ringer associated with a media file stored in the remote mobile device, inducing mechanical vibrations on the body of the remote mobile device for a predefined event, locking accessibility of the remote mobile device, and disconnecting the remote mobile device from external radio waves.

The client application invokes operations comprising, for example, forwarding messages to one or more second remote mobile devices based on instructions obtained from the commands, capturing and storing media content for a predetermined period of time on the remote mobile device, and placing a call to one or more second remote operating devices based on instructions obtained from the commands and the parameters on the remote mobile device. In an embodiment, the operation invoked is a continuous operation comprising, for example, retrieving incoming messages, outgoing messages, and call records from the remote mobile device on a real time basis.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of establishing communication with a remote mobile device and inducing one or more functionalities on the remote mobile device.

FIG. 2 illustrates a system for establishing communication with a remote mobile device and inducing one or more functionalities on the remote mobile device.

FIG. 3 exemplarily illustrates the architecture of a computer system used for communicating with a remote mobile device and inducing one or more functionalities on the remote mobile device.

FIG. 4 exemplarily illustrates a flowchart comprising the steps involved in establishing communication with a remote mobile device and inducing one or more functionalities on the remote mobile device.

FIG. 5 exemplarily illustrates the request-response based communication between two remote mobile devices.

FIG. 6 exemplarily illustrates a screenshot of a graphical user interface provided by the client application, displaying a list of commands associated with the functionalities.

FIGS. 7A-7C exemplarily illustrate flowcharts comprising the steps of inducing one or more functionalities on a remote mobile device via a controlling communication device.

FIGS. 8A-8C exemplarily illustrate a flowchart comprising the steps of remotely invoking operations on a remote mobile device via a controlling communication device.

### DETAILED DESCRIPTION OF THE INVENTION

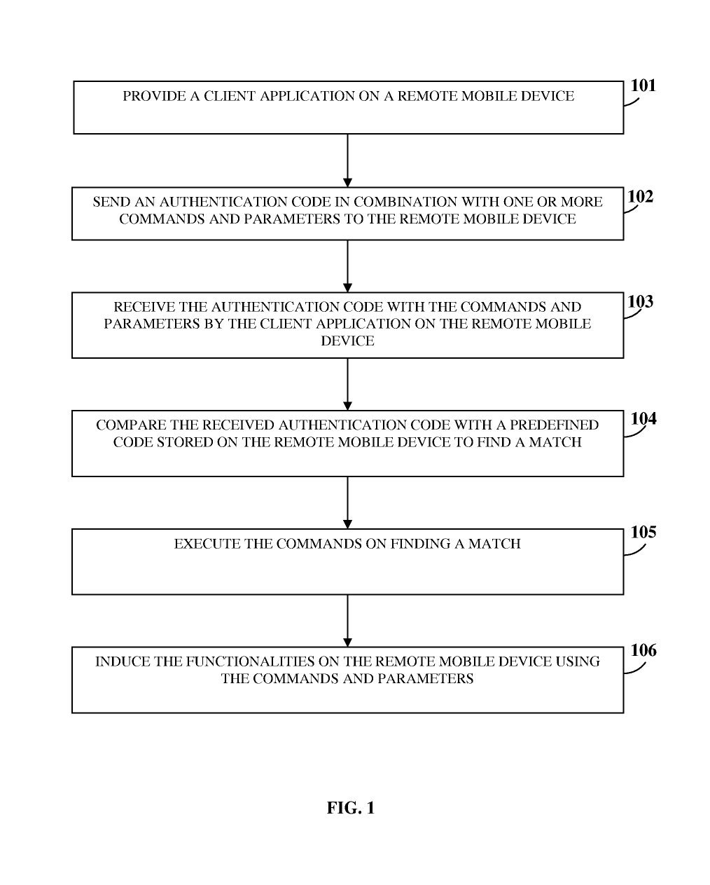

FIG. 1 illustrates a method of establishing communication with a remote mobile device and inducing one or more functionalities on the remote mobile device. The remote mobile device is, for example, a mobile phone, a personal digital assistant (PDA), a laptop, etc. A client application is provided 101 on the remote mobile device. The client application is, for example, installed on the remote mobile device. A user, for example, the owner of the remote mobile device sends 102 an authentication code in combination with one or more commands and parameters to the client application on the remote mobile device using, for example, a short message service (SMS) message. The SMS message is, for example, a text SMS message, a voice SMS message, etc. The owner of the remote mobile device uses an alternative controlling communication device to send the authentication code with the commands and parameters to the client application on the remote mobile device. The controlling communication device is, for example, a mobile phone, a personal digital assistant, a personal computer, a laptop, or other communication devices. The commands and parameters are sent to the client application of the remote mobile device in a format, for example, “password.command parameters”. The string “password” is the authentication code, the string “command” comprises an instruction to induce one of the functionalities, and the string “parameters” comprises none or one or more parameters.

The client application on the remote mobile device receives 103 the authentication code with the commands and parameters from the controlling communication device. The commands and the associated parameters are received in a format that is recognizable by the client application. In an embodiment, the commands are predefined by the owner of the remote mobile device. The default command name, structure, and format can be modified by the owner of the remote mobile device. The client application compares 104 the received authentication code with a predefined code stored on the remote mobile device to find a match. The predefined code is defined by the owner of the remote mobile device and one or more of the parameters are predefined by the client application on the remote mobile device. In the event of a match, the client application may also authenticate the controlling communication device number from which the client application received the authentication code to establish the communication. The client application sends a response to the remote mobile device using, for example, an SMS message to confirm success or failure of the authentication.

The client application executes 105 the commands on finding a match. The commands comprise instructions to induce one or more functionalities on the remote mobile device. The client application induces 106 the functionalities on the remote mobile device on execution of the commands using the parameters. The functionalities comprise, for example, retrieving information from the remote mobile device, modifying settings of the remote mobile device, and invoking operations on the remote mobile device.

A functionality that can be induced on the remote mobile device is, for example, performing a playback of a media file on the remote mobile device and simultaneously performing a recording operation by the remote mobile device. The media file, for example, an audio file, a video file, etc. may be stored in a storage medium on the remote mobile device. The recording operation is performed using, for example, an audio input device such as a microphone for giving the user a “reaction” audio file to the sound that was played. In an embodiment, an audio recording or a video recording operation is performed in the background, and there is no identifiable indication that the remote mobile device is performing the recording operation. The playback operation is, for example, performed by looping the media file on the remote mobile device. The audio file or video file is recognizable by the name associated with the audio file or video file on the remote mobile device and the extension format, for example, “.mp3” denoting the moving picture experts group audio layer-3 file format on the remote mobile device.

The owner of the remote mobile device may also instruct the client application on the remote mobile device to terminate the simultaneous playback and recording operation, store the recorded file on the storage medium of the remote mobile device, retrieve the stored file, and initiate the playback of the retrieved file on the remote mobile device by sending one or more SMS messages.

The owner of the remote mobile device may also retrieve location information of the remote mobile device. For example, the owner sends a command “.getLocation” to the client application on the remote mobile device. The command retrieves information about the location of the remote mobile device, and the command may be sent without any associated parameters. On receiving the command, the client application checks for a hierarchy of network providers to ascertain the availability of a global positioning system (GPS). In the event of the availability of a GPS on the remote mobile device, the client application sends, for example, an SMS response containing the GPS coordinates of the remote mobile device to the owner's controlling communication device. In the event of unavailability of a GPS, the client application retrieves the coordinates of the location of the remote mobile device by using, for example, Wi-Fi, mobile networks, or a combination thereof. The client application conveys the coordinates, for example, in the form of a Google® Maps link to the controlling communication device. The Google Maps link provides an option for a receiver to view the location of the remote mobile device on a map on mobile devices that are internet-enabled. The mode of retrieving information about the location of the remote mobile device is determined by the owner of the remote mobile device.

The owner of the remote mobile device may also retrieve call logs of the remote mobile device, for example, on a real time basis. The call logs comprise information, for example, time, duration, phone number, etc. of incoming calls received by the remote mobile device, outgoing calls made from the remote mobile device, and incoming calls missed by the remote mobile device. The client application retrieves the call logs in a combination with information about the current location of the remote mobile device by executing the command, for example, “setSpyMode Phone Number” sent by the owner from the controlling communication device. The command comprises the optional parameter “Phone Number”. The parameter is substituted with the phone number to which the retrieved call logs and the current location of the remote mobile device are to be forwarded. The command “setSpyMode Phone Number” makes the owner of the remote mobile device aware of ongoing activities on a real time basis, for example, when a call is placed, the number being called, when a call is answered, the incoming phone number, etc. The current location is retrieved by executing the command “.getLocation”. The retrieval of call logs enables the owner using the authenticated controlling communication device to assess whether the remote mobile device, in the event of misplacement, theft, misuse, etc. is being used by another user. The retrieval of the location information enables the owner to determine the location of the other user who is using the remote mobile device.

The client application may deactivate the functionality provided by the command “.setSpyMode” when the client application receives and executes a command “.endSpyMode” without any associated parameters from the authenticated controlling communication device.

The owner of the remote mobile device can invoke an operation on the remote mobile device, for example, an operation of placing a call to a number specified within the command “.spy [number]”. The client application switches the remote mobile device to speakerphone mode, and places a phone call to the specified number without user interaction. This allows the owner, available on the specified number, to answer the call placed by the remote mobile device and listen in on a potential thief of the remote mobile device.

The owner may also retrieve the incoming calls received by the remote mobile device, outgoing calls made from the remote mobile device, and the incoming calls missed by the remote mobile device by sending the commands, for example, “.getIncomingCalls”, “.getOutgoingCalls” and “.getMissedCalls” respectively. The parameter, for example, “How Many” is sent with the commands. The string “HowMany” is substituted with the value of a positive whole number. In the event when the optional parameter is not specified, the client application sends a predefined number of calls as a list to the authenticated controlling communication device by, for example, one or more SMS messages.

The information retrieved by the client application on the remote mobile device further comprises contact information, for example, one or more phone numbers of one or more contacts stored on the remote mobile device. For example, the client application may receive the command “.getContact Contact Name” from the authenticated controlling communication device. “Contact Name” is an associated parameter and comprises the name of the contact whose one or more phone numbers matching one or more instances of the contact name are retrieved by the client application. A person may, for example, have three phone numbers, one pertaining to a work phone, another for a home phone, and another for a mobile phone. The client application recognizes the parameter “Contact Name” associated with the command “.getContact”, and retrieves the available phone numbers associated with the specified contact name. The owner using the authenticated controlling communication device receives the available phone numbers associated with the specified contact name, and has more means of access to the contact person who is being queried for.

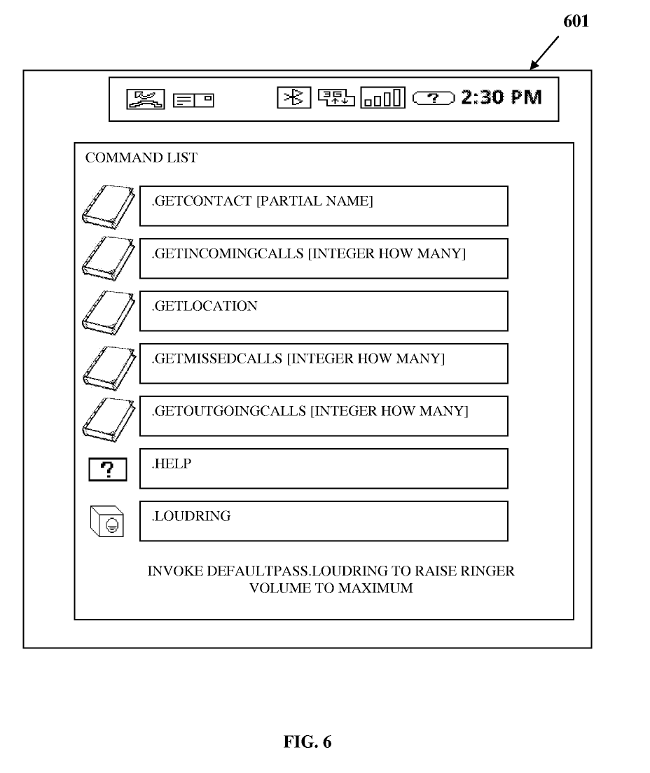

The owner of the remote mobile device may also retrieve the commands associated with the functionalities embodied in the method disclosed herein. The client application sends the descriptions of the commands to the controlling communication device if specified in the request command from the authenticated controlling communication device. A screenshot of a graphical user interface 601 provided by the client application, displaying a list of commands associated with the functionalities is exemplarily illustrated in FIG. 6.

Another functionality that can be induced on the remote mobile device is, for example, modifying settings of the remote mobile device. The modification comprises, for example, enabling and disabling a GPS on the remote mobile device, adjusting volume of a ringer associated with a media file stored in the remote mobile device, inducing mechanical vibrations on the body of the remote mobile device for a predefined event, locking accessibility of the remote mobile device, and disconnecting the remote mobile device from external radio waves.

The GPS on the remote mobile device may be enabled or disabled by, for example, the command “.toggleGPS”. For example, if the GPS is disabled on the remote mobile device, the command “.toggleGPS” enables GPS and vice versa. The command is not associated with any parameters. The information about the state of the remote mobile device after execution of the command by the client application, and the change initiated, are conveyed to the authenticated controlling communication device.

The client application may raise the ringer volume of the remote mobile device to maximum volume by executing a command, for example, “.loudRing”. The client application may deactivate the ringer volume by executing a command, for example, “.silence”. The commands “.loudRing” and “.silence” may not be associated with any parameter. Raising the ringer volume allows the remote mobile device to be easily traced by calling the remote mobile device.

The client application may induce mechanical vibrations on the body of the remote mobile device for a predefined event. The predefined event is, for example, one or more of an incoming call, a missed call, an incoming message, and a notification. This setting is activated by the command, for example, “.vibrate”. The command may not be associated with any parameter.

The owner of the remote mobile device may lock accessibility of the remote mobile device by sending the command “.setLock” to the client application on the remote mobile device. The command may not be associated with any parameter. On receiving the command, the client application modifies a setting on the remote mobile device that governs that a user must provide a predefined password or pattern as input to access the remote mobile device. The command modifies the setting to actualize the locking mechanism, by which the owner can choose to disable the locking mechanism of the remote mobile device while the owner has possession of the remote mobile device. Disabling the locking mechanism avoids the unnecessary password authenticated unlocking when the owner of the remote mobile device is in possession of the remote mobile device. In the event of misplacement, theft or misuse of the remote mobile device, the owner may use the command to activate the locking mechanism on the remote mobile device. Activating the locking mechanism bars an unauthorized user from accessing any functionality of the remote mobile device until the user provides the predefined password or pattern as input. In an embodiment, a user of the remote mobile device may be allowed to make an emergency call when the mobile device is locked.

The owner of the remote mobile device may disconnect the remote mobile device from external waves, for example, radio traffic and connections, by sending the command, for example, “.setAirplaneMode” to the client application on the remote mobile device. The command changes a setting of the remote mobile device to true for disconnecting the phone from external waves.

Operations that may be invoked on the remote mobile device comprise, for example, forwarding messages to the controlling communication device or one or more second remote mobile devices based on instructions obtained from the commands. Another operation comprises, for example, capturing and storing media content for a predetermined period of time on the remote mobile device. Messages may be forwarded to the second remote mobile devices based on instructions obtained from the command “.setForward”. The command may be associated with an optional parameter “Phone Number”.

Messages, for example, a text message, a voice message, etc., may be forwarded to a person whose phone number or contact number is sent from the authenticated controlling communication device to the client application on the remote mobile device. The phone number or contact number of the person is specified in a command, for example, “.sendSMS phone # message”. The parameter “phone#” is substituted by the phone number of the person to whom the text message is to be forwarded. The parameter “message” is substituted by the message to be forwarded. An embodiment of the operation of forwarding a text message to a second mobile device comprises sending the command, “.sendSMS” in combination with a command, for example, “byContact” and appending the parameter “Contact Name”. The “byContact” command induces the functionality of retrieving one or more available phone numbers of the contact whose name is specified in the parameter “Contact Name”. The owner using the authenticated controlling communication device may combine the command “.sendSMS” with the command “.setForward” for receiving one or more responses from the phone number to which the text message has been sent.

In an embodiment, a forward number may be set on the remote mobile device. The forward number is the phone number of the authenticated controlling communication device that communicates with the remote mobile device. The forward number is embodied as an optional parameter “Phone Number”. The string “Phone Number” is substituted by the forward number and the parameter is associated with the command “.setForward”. The command is sent via SMS to the client application. On receiving the command, the client application retrieves one or more resident incoming calls and one or more received text messages on the remote mobile device and forwards the retrieved information to the number specified in the parameter. More specifically, the forward functionality embodies conveying to the phone number of the authenticated controlling communication device, the phone number of the retrieved incoming call, the time of the incoming call, and the phone number and content of the SMS messages that the remote mobile device received. In the event when no associated parameter is sent with the SMS message comprising the command, the client application stores the number from which the SMS message was received, as the number to which incoming calls and SMS messages information should be conveyed.

In an embodiment, the forward number set by the command “.setForward” may be deactivated on the remote mobile device by sending a command, for example, “.endForward” from the controlling communication device. The “.endForward” command ceases the forward operations activated by the “.setForward” command. The command is not associated with any parameters.

Another functionality that can be induced on the remote mobile device is, for example, activating the media recording mechanism on the remote mobile device, storing the recording media file to a temporary file, and continuing the recording functionality until the owner using the authenticated controlling communication device deactivates the recording mechanism on the remote mobile device by sending another message. The client application actuates the option of prompting the user of the authenticated controlling communication device through a user interface on the authenticated controlling communication device to fill out a form. When the client application receives a command to deactivate the ongoing recording functionality, the recorded media file may be sent to the authenticated controlling communication device by, for example, electronic mail (email).

Another functionality that can be induced on the remote mobile device is, for example, activating the image capture functionality on the remote mobile device. The image capture functionality captures an image when a command from the owner of the authenticated controlling communication device is received by the client application immediately or after a specified duration of time specified by the owner.

Another functionality that can be induced on the remote mobile device is, for example, activating the playback of a media file at maximum volume and looping the media file repeatedly. A command, for example, “.findMe”, activates the playback at maximum volume. The command is used without any parameters.

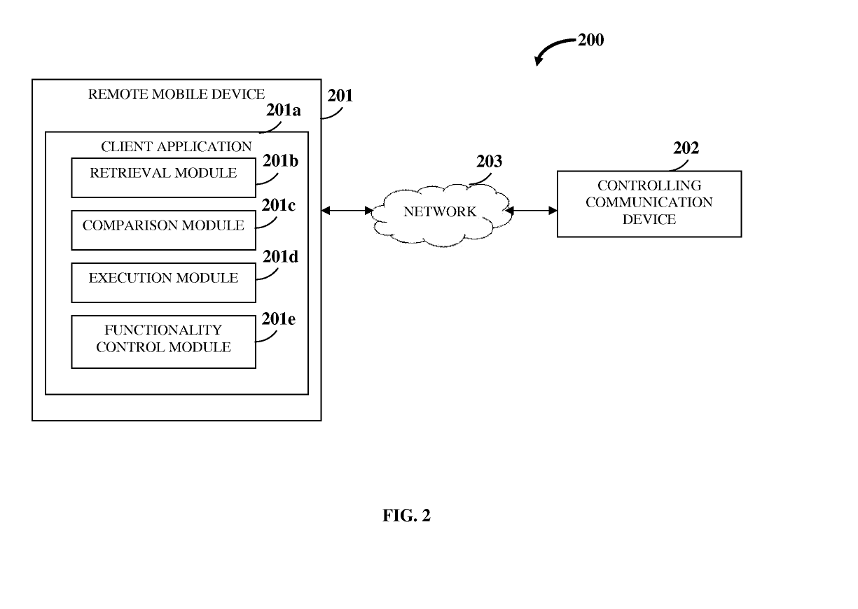

FIG. 2 illustrates a system 200 for establishing communication with a remote mobile device 201 and inducing one or more functionalities on the remote mobile device 201. The system 200 disclosed herein comprises a remote mobile device 201 comprising a client application 201a, and a controlling communication device 202 connected via a network 203, for example, a cellular network. As used herein, the controlling communication device 202 is a communication device used by the owner of the remote mobile device 201 to send an authentication code with the commands and parameters to the client application 201a on the remote mobile device 201 for remotely controlling the remote mobile device 201. The remote mobile device 201 and the controlling communication device 202 are, for example, cellular mobile communication devices. The client application 201a comprises a retrieval module 201b, a comparison module 201c, an execution module 201d, and a functionality control module 201e. The authentication code with one or more commands and parameters is sent to the client application 201a on the remote mobile device 201 using, for example, a short message service (SMS) message. The retrieval module 201b receives the authentication code with one or more commands and parameters. For example, the retrieval module 201b is configured to parse incoming messages to recognize an authentication code and the appended commands and parameters in the body of the message. The comparison module 201c compares the received authentication code with a predefined code stored on the remote mobile device 201 to find a match. The execution module 201d executes one or more of commands on finding a match. The commands comprise instructions to induce one or more functionalities on the remote mobile device 201. The functionality control module 201e induces one or more functionalities on the remote mobile device 201 on execution of the commands.

The functionality control module 201e performs playback of a media file and simultaneously performs a recording operation on the remote mobile device 201 based on the commands and the parameters. The functionality control module 201e retrieves information from the remote mobile device 201 based on the commands and parameters. The information that can be retrieved comprises, for example, geographical location of the remote mobile device 201, call logs, and media files stored on the remote mobile device 201, and information of contacts stored on the remote mobile device 201. The client application 201a sends the retrieved information to the controlling communication device 202 or one or more second remote mobile devices.

The functionality control module 201e modifies settings of the remote mobile device 201 based on the commands and parameters. For example, the functionality control module 201e enables or disables a global positioning system (GPS) on the remote mobile device 201, adjusts volume of a ringer associated with a media file stored in the remote mobile device 201, induces mechanical vibrations on the body of the remote mobile device 201 for a predefined event, locks accessibility of the remote mobile device 201, disconnects the remote mobile device 201 from external waves, etc. The functionality control module 201e can invoke an operation on the remote mobile device 201 based on the commands and the parameters. The operations invoked on the remote mobile device 201 comprise, for example, forwarding messages to one or more second remote mobile devices based on instructions obtained from the commands, capturing and storing media for a predetermined period of time on the remote mobile device 201, and automatically placing a call to one or more second remote mobile devices based on instructions obtained from the commands and parameters. In an embodiment, the functionality control module 201e invokes a continuous operation of retrieving incoming messages, outgoing messages, and call records from the remote mobile device 201 on a real time basis.

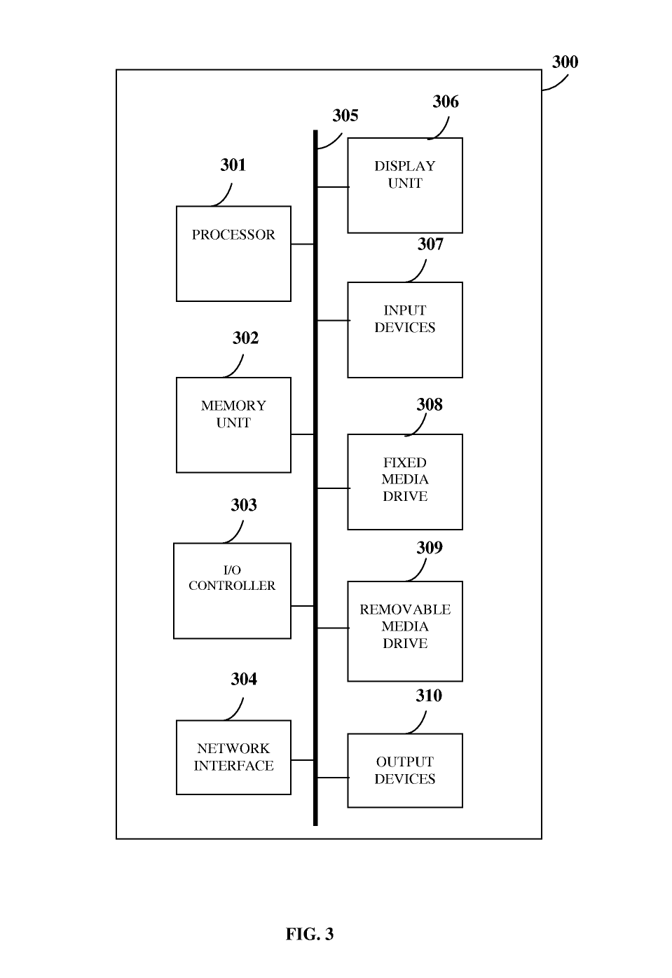

FIG. 3 exemplarily illustrates the architecture of a computer system 300 used for communicating with a remote mobile device 201 and inducing one or more functionalities on the remote mobile device 201. The remote mobile device 201 and the controlling communication device 202 employ the architecture of the computer system 300 exemplarily illustrated in FIG. 3.

The remote mobile device 201 and the controlling communication device 202 communicate with each other via the network 203. The network 203 is, for example, a wireless network, a wired network, a cellular network, a satellite network, etc. The computer system 300 comprises, for example, a processor 301, a memory unit 302 for storing programs and data, an input/output (I/O) controller 303, a network interface 304, a network bus 305, a display unit 306, input devices 307, a fixed media drive 308, a removable media drive 309, an output device 310, for example, a speaker, etc.

The processor 301 is an electronic circuit that executes computer programs. The memory unit 302 is used for storing programs, applications, and data. For example, the client application 201a is stored on the memory unit 302 of the computer system 300 of the remote mobile device 201. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The network interface 304 enables connection of the computer system 300 to the network 203. The I/O controller 303 controls the input and output actions performed by the user. The network bus 305 permits communication between the modules, for example, 201b, 201c, 201d, and 201e of the computer implemented system 200 disclosed herein.

The display unit 306 displays information to the user. For example, a list of commands and their corresponding functions sent by the client application 201a on the remote mobile device 201 are displayed to the owner via the display unit 306 of the controlling communication device 202. The input devices 307 are used for inputting data into the computer system 300. The input devices 307 are, for example, a keyboard such as an alphanumeric keyboard, a joystick, a mouse, a touch pad, a light pen, etc. The computer system 300 further comprises a fixed media drive 308 and a removable media drive 309 for receiving removable media.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly through the network 203. Computer applications and programs are executed by double clicking a related icon displayed on the display unit 306 using one of the input devices 307. The user interacts with the computer system 300 using a graphical user interface (GUI) of the display unit 306.

The computer system 300 of the remote mobile device 201 and the controlling communication device 202 employs operating systems for performing multiple tasks. An operating system is responsible for the management and coordination of activities and the sharing of the resources of the computer system 300. The operating system further manages security of the computer system 300, peripheral devices connected to the computer system 300, and network connections. The operating system employed on the computer system 300 recognizes, for example, inputs provided by the user using one of the input devices 307, the output display, files and directories stored locally on the fixed media drive 308, etc. The operating system on the computer system 300 of the remote mobile device 201 executes different programs initiated by the user using the processor 301. Instructions for executing the client application 201a are retrieved by the processor 301 from the program memory in the form of signals. Location of the instructions in the program memory is determined by a program counter (PC). The program counter stores a number that identifies the current position in the program of the client application 201a.

The instructions fetched by the processor 301 from the program memory after being processed are decoded. After processing and decoding, the processor 301 executes the instructions. For example, the retrieval module 201b defines instructions for receiving an authentication code with one or more commands and parameters. The comparison module 201c defines instructions for comparing the received authentication code with a predefined code stored on the remote mobile device 201 to find a match. The execution module 201d defines instructions for executing the commands on finding a match. The functionality control module 201e defines instructions for inducing one or more functionalities on the remote mobile device 201 using the parameters, etc. which are stored in the program memory or received from the controlling communication device 202.

The processor 301 retrieves the instructions defined by the retrieval module 201b, the comparison module 201c, the execution module 201d, and the functionality control module 201e, and executes the instructions.

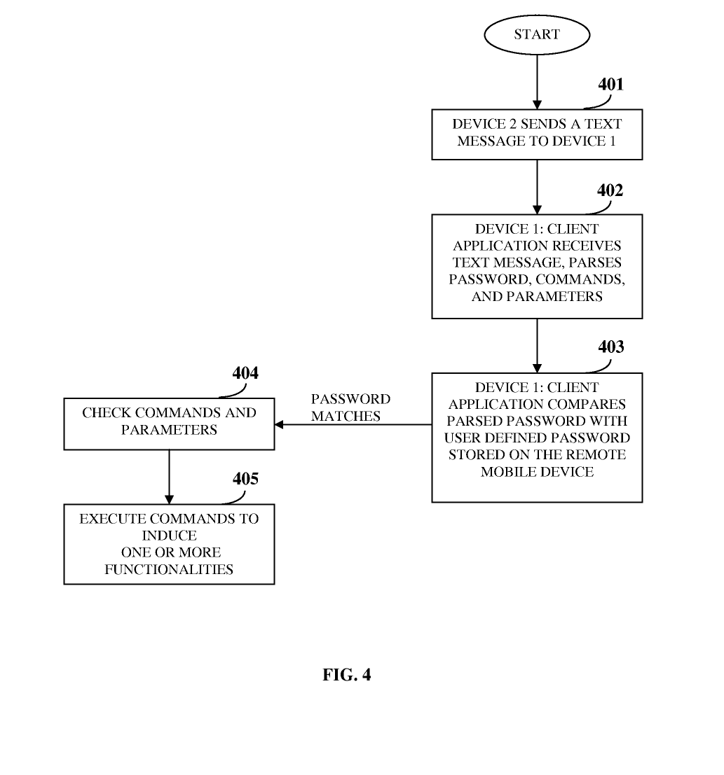

FIG. 4 exemplarily illustrates a flowchart comprising the steps involved in establishing communication with a remote mobile device 201 and inducing one or more functionalities on the remote mobile device 201. The remote mobile device 201 which may be misplaced, stolen or misused and is therefore untraceable, is herein referred to as “Device 1”. The owner of Device 1 201 sends 401, for example, a text message from a controlling communication device 202 herein referred to as “Device 2” to Device 1 201. Device 1 201 and Device 2 202 are, for example, mobile phones. The client application 201a installed on Device 1 201 receives 402 the text message. On receiving the text message, the client application 201a parses 402 the received text message which comprises an authentication password, commands, and parameters. The client application 201a compares 403 the parsed password in the text message with a user defined password that was defined by the owner of Device 1 201 prior to the event that Device 1 201 was untraceable. If the parsed password matches with the user defined password, the client application 201a on Device 1 201 checks 404 the commands and parameters. The commands and parameters are associated with instructions that induce one or more functionalities on Device 1 201. The client application 201a executes 405 the commands to induce the functionalities associated with the commands, for example, retrieving information from Device 1 201, modifying the settings on Device 1 201, and invoking operations on Device 1 201.

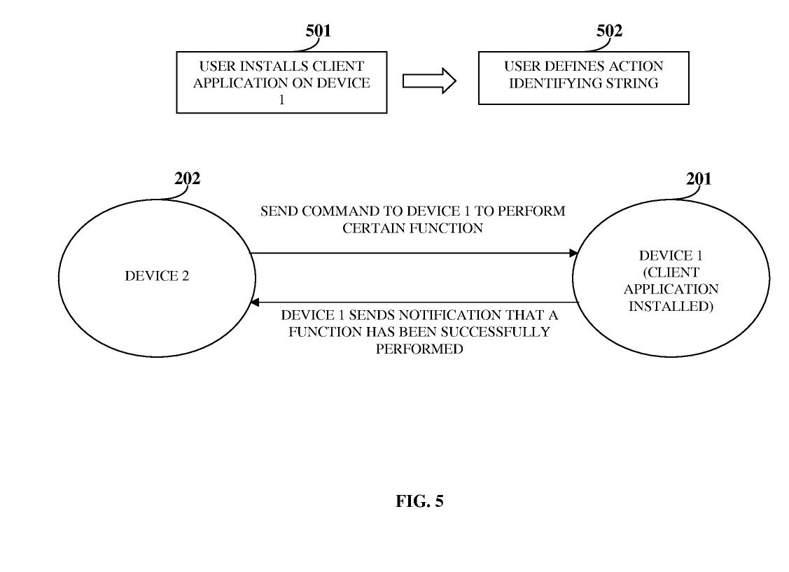

FIG. 5 exemplarily illustrates the request-response based communication between two remote mobile devices 201 and 202, herein referred to as Device 1 201 and Device 2 202 respectively. Device 2 202 is used by the owner of Device 1 201 in the event that Device 1 201 is misplaced, stolen, or misused, and therefore untraceable. The owner of the Device 1 201 herein referred to as a “user”, installs 501 the client application 201a on Device 1 201. The user defines 502 an action that identifies the string. The string refers to a sequential combination of alphabets. Device 2 202 sends a command to Device 1 201 instructing Device 1 201 to perform a certain specified function. The function is, for example, a request for contact information, a request to change or modify a setting on Device 1 201, etc. Device 1 201 sends a notification to Device 2 202 that a function has been successfully performed. For example, Device 1 201 responds to Device 2 202 by sending the requested contact information and/or by sending a notification that the specified setting has been modified.

FIG. 6 exemplarily illustrates a screenshot of a graphical user interface 601 provided by the client application 201a, displaying a list of commands associated with the functionalities. The command list comprises the commands, for example, “.getContact”, “.getIncomingCalls”, “.getLocation”, “.getMissedCalls”, “.getOutgoingCalls”, “.help”, and “.loudRing”. The command “Defaultpass.loudRing” is used to raise the ringer volume to maximum volume. When a command is selected from the command list, the description of the functionality associated with the command is displayed to the owner of the remote mobile device 201. The owner can then send commands using the controlling communication device 202 to induce functionalities on the remote mobile device 201.

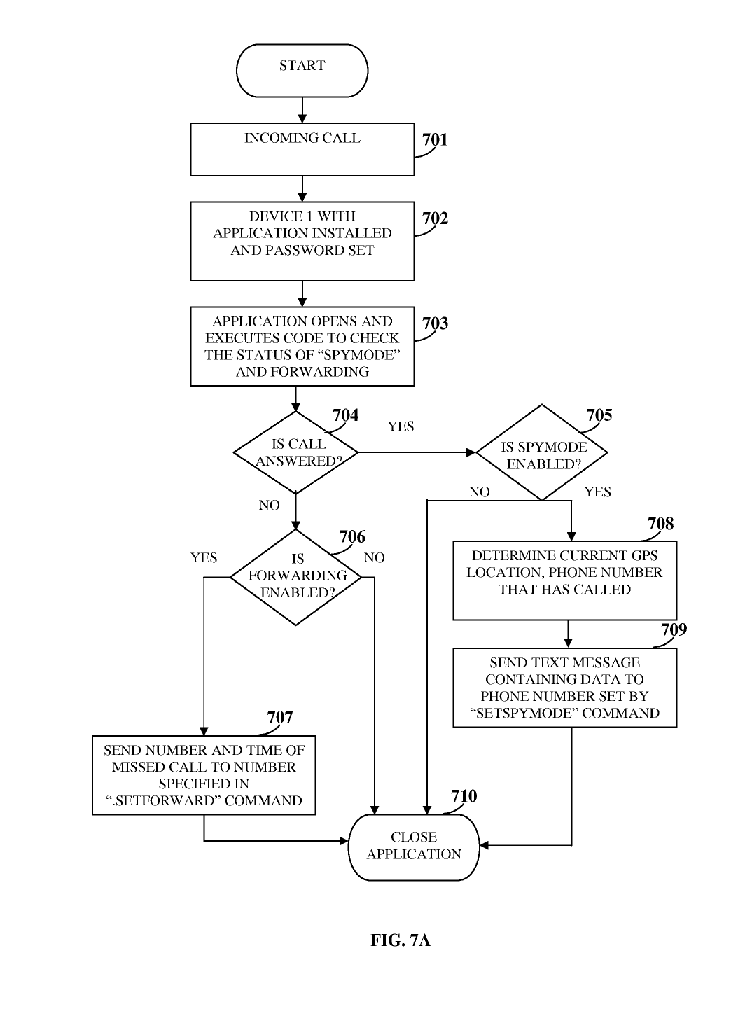

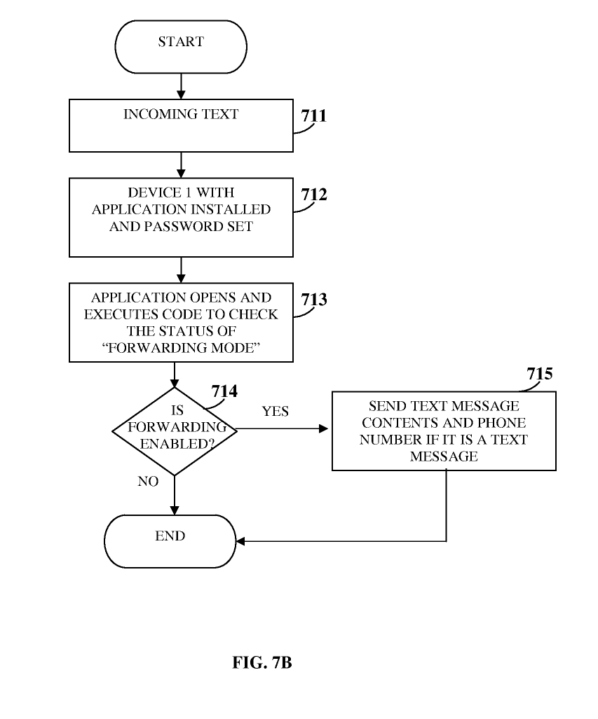

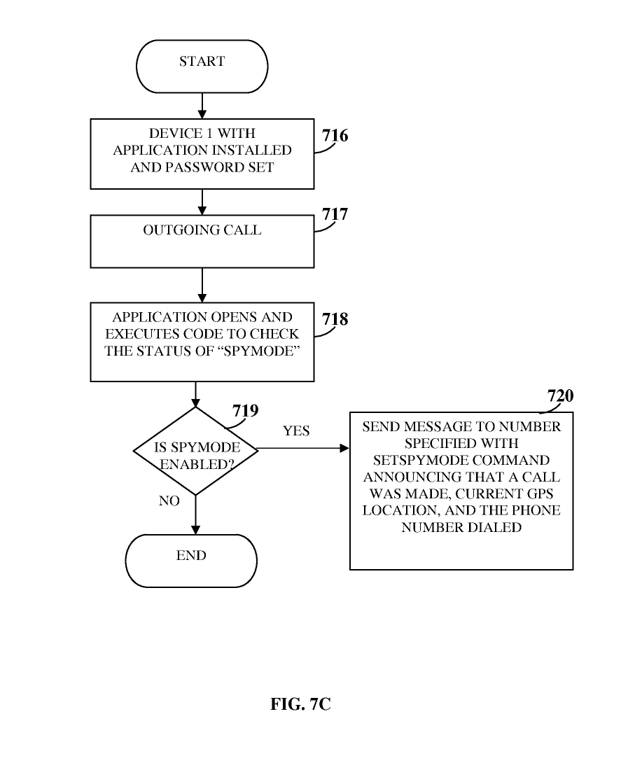

FIGS. 7A-7C exemplarily illustrate a flowchart comprising the steps of inducing one or more functionalities on a remote mobile device 201 via a controlling communication device 202. An owner of the remote mobile device 201 herein referred to as “Device 1” utilizes a controlling communication device 202 herein referred to as “Device 2” to induce one or more functionalities on Device 1 201. Device 1 201 is installed 702 with the client application 201a and is set 702 with a user defined password. The owner can forward calls and messages or the details of the calls and messages received by Device 1 201 to a specified number and can track outgoing calls placed by Device 1 201 via Device 2 202.

Consider an example, as illustrated in FIG. 7A, where an incoming call 701 is received by Device 1 201. On receiving commands from Device 2 202, the client application 201a on Device 1 201 opens and executes 703 code to check the status of the “SpyMode” and the “Forwarding” mode configured on Device 1 201. The client application 201a then checks 704 whether the incoming call is answered. If the incoming call is not answered, the client application 201a checks 706 whether the “Forwarding” mode is enabled. If the “Forwarding” mode is not enabled, the client application 201a is closed 710 and the operation is terminated. If the “Forwarding” mode is enabled, the client application 201a sends 707 the number and time stamp of the missed call to the phone number specified in the “.setForward” command received by the client application 201a.

If the incoming call is answered, the client application 201a checks 705 whether “SpyMode” is enabled. If the “SpyMode” is not enabled, the client application 201a is closed 710 and the operation is terminated. If the “SpyMode” is enabled, the client application 201a determines 708 the current GPS location of Device 1 201 and the phone number of the incoming call. The client application 201a then sends 709, for example, a text message containing the determined GPS location and phone number of the incoming call to the phone number specified in the “.setSpyMode” command received by the client application 201a.

Consider another example, as illustrated in FIG. 7B, where an incoming text message 711 is received by Device 1 201. Device 1 201 is already installed 712 with the client application 201a and is set 712 with a user defined password. On receiving commands from Device 2 202, the client application 201a opens and executes 713 code to check the status of the “Forwarding” mode. The client application 201a checks 714 whether the “Forwarding” mode is enabled. If the “Forwarding” mode is not enabled, the client application 201a terminates operation. If the “Forwarding” mode is enabled, the client application 201a sends 715 the content of the incoming text message and phone number from where the text message was sent, to the phone number specified in the “.setForward” command received by the client application 201a.

Consider an example, as illustrated in FIG. 7C, where Device 1 201 makes an outgoing call 717. Device 1 201 is already installed 716 with the client application 201a and is set 716 with a user defined password. On receiving commands from Device 2 202, the client application 201a opens and executes 718 code to check the status of the

“SpyMode”. The client application 201a checks 719 whether “SpyMode” is enabled. If the “SpyMode” is not enabled, the client application 201a terminates operation. If the “SpyMode” is enabled, the client application 201a determines the current GPS location of Device 1 201, the phone number that was dialed, the time stamp, etc. The client application 201a then sends 720, for example, a text message declaring that a phone call was made along with the GPS location, the dialed phone number, the time stamp, etc. to a phone number specified in the “.setSpyMode” command received by the client application 201a.

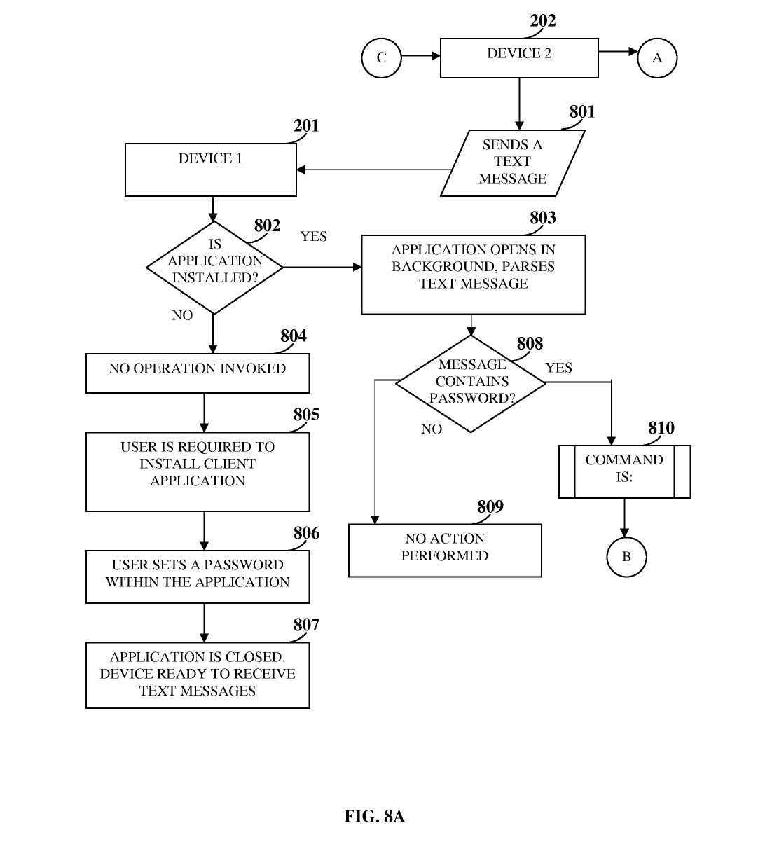

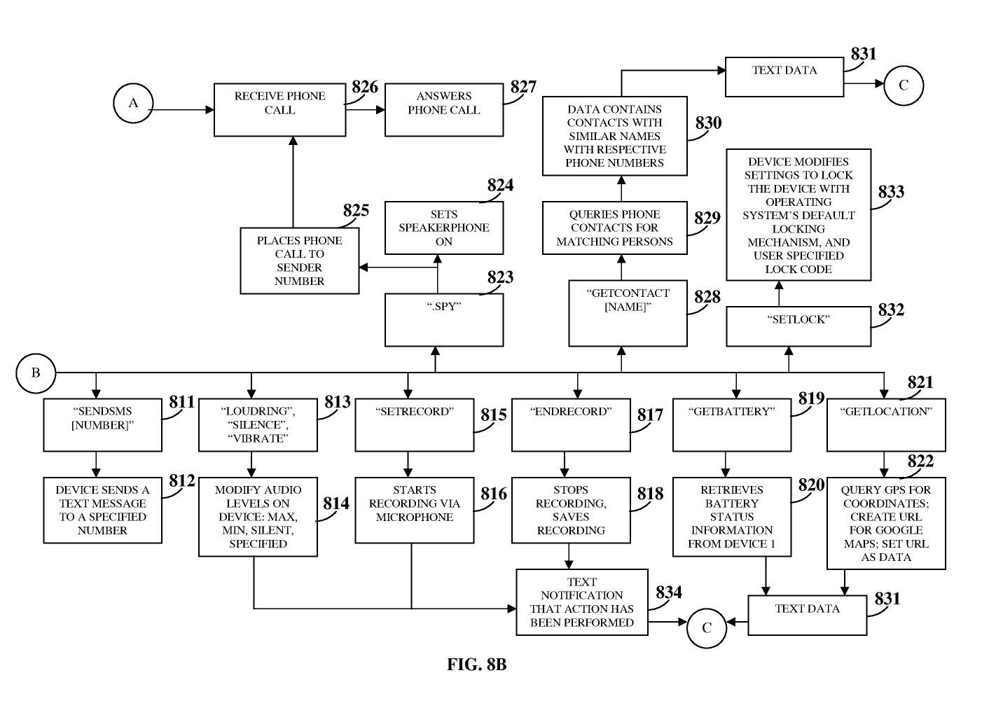

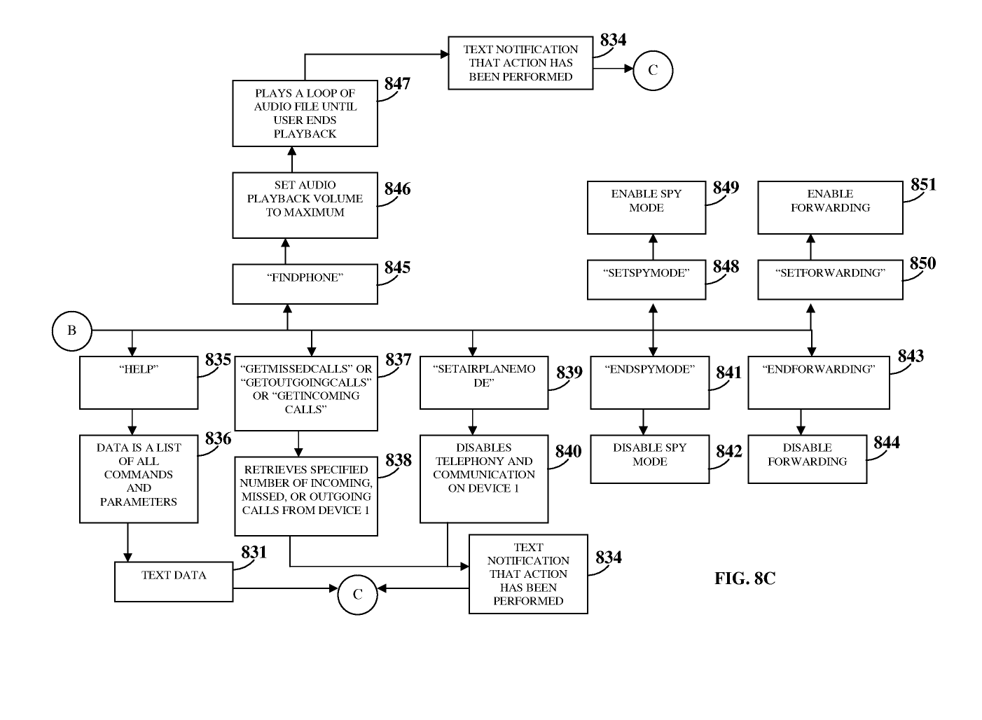

FIGS. 8A-8C exemplarily illustrate a flowchart comprising the steps of remotely invoking operations on a remote mobile device 201 via a controlling communication device 202. On receiving a text message 801 sent from the controlling communication device 202 herein referred to as “Device 2”, the remote mobile device 201 herein referred to as “Device 1” is required 802 to have the client application 201a installed on the Device 1 201 to allow the owner to remotely invoke operations on the Device 1 201. If the client application 201a is absent on Device 1 201, the message from Device 2 202 does not invoke 804 any operation on Device 1 201, and the user, herein the owner, is required to install 805 the client application 201a on Device 1 201. On installing the client application 201a, the owner sets 806 a password within the client application 201a, and the application is closed 807. Device 1 201 is now ready to receive, for example, text messages. If the client application 201a is installed on Device 1 201, the client application 201a is invoked or opened 803 in the background and parses, for example, text messages sent by the owner using Device 2 202. The owner sends 801 text messages with commands to Device 1 201 using Device 2 202. The client application 201a on Device 1 201 checks 808 whether each of the text messages contains a password for authentication. If each of the text messages does not contain a password, the client application 201a terminates operation and does not perform 809 any action. If each of the text messages contains a password, the client application 201a compares the password with the preset password on Device 1 201 to find a match. On finding the match, the client application 201a executes the commands 810 comprising instructions contained in the text messages to induce one or more functionalities on Device 1 201. The commands are, for example, “sendsms [number]”, “loudring”, “silence”, “vibrate”, “setRecord”, “endRecord”, “getbattery”, “.spy”, “.getLocation”, “findphone”, “setLock”, “setSpyMode”, “endSpyMode”, “SetForwarding”, “EndForwarding”, “getContact [name]”, “help”, “setAirPlaneMode”, “getMissedCalls”, “getOutgoingCalls”, “getIncomingCalls”, etc.

On receiving the “sendsms [number]” command 811, the client application 201a on Device 1 201 sends 812 a text message to the specified number. On receiving the “loudring”, “silence”, and “vibrate” commands 813, the client application 201a on Device 1 201 modifies 814 the audio levels to maximum, minimum, silent, with vibrations, etc. as specified.

On receiving the “.spy” command 823, the client application 201a sets or activates 824 the speakerphone mode on Device 1 201 and places 825 a phone call to Device 2 202. On receiving 826 the phone call by Device 2 202, the owner using Device 2 202 can answer 827 the call placed by Device 1 201 and listen in on a potential thief of

Device 1 201. The owner can then send a command, for example, “setRecord” 815 to start 816 recording the conversation via a microphone, and a command “endRecord” 817 to stop and save 818 the recording.

On receiving the “getbattery” command 819, the client application 201a retrieves 820 battery status information from Device 1 201. The client application 201a then sends 831, for example, a text message containing the battery status information to Device 2 202. On receiving the “.getLocation” command 821, the client application 201a on Device 1 201 queries 822 the GPS for coordinates, creates a uniform resource locator (URL) for Google Maps, and sets the URL as data. The client application 201a then sends 831, for example, a text message containing the data to Device 2 202.

On receiving the “getContact [name]” command 828, the client application 201a queries 829 the phone contacts list on Device 1 201 for matching persons. The client application 201a then sends 831 a text message containing data 830 on contacts with similar names and their respective phone numbers to Device 2 202. On receiving the “setLock” command 832, the client application 201a on Device 1 201 modifies 833 settings to lock Device 1 201 using a default locking mechanism and a user specified locking code.

On receiving the “help” command 835, the client application 201a on Device 1 201 sends 831 a text message to Device 2 202 with a list 836 of all commands and parameters stored on Device 1 201. On receiving the “findphone” command 845, the client application 201a on Device 1 201 sets 846 the audio playback volume to maximum and plays 847 a loop of an audio file until Device 1 201 is found and the user ends the playback.

On receiving the “getMissedCalls”, “getOutgoingCalls”, and “getIncomingCalls” commands 837, the client application 201a retrieves 838 a specified number of missed calls, outgoing calls, and incoming calls respectively from the call directory of Device 1 201. On receiving the “setAirPlaneMode” command 839, the client application 201a disables 840 telephony and communication on Device 1 201.

On receiving the “setSpyMode” command 848, the client application 201a enables 849 the “Spy Mode” on Device 1 201. On receiving the “endSpyMode” command 841, the client application 201a disables 842 the “Spy Mode” on Device 1 201. On receiving the “SetForwarding” command 850, the client application 201a enables 851 “Forwarding” on Device 1 201. On receiving the “EndForwarding” command 843, the client application 201a disables 844 “Forwarding” on Device 1 201.

The client application 201a on Device 1 201 also sends a text notification 834 to Device 2 202 indicating that the above mentioned actions were performed on Device 1 201.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, Perl, Python, or JAVA. The software programs may be stored on or in one or more mediums as an object code. A computer program product comprising computer executable instructions embodied in a computer readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of establishing communication with a remote mobile device and inducing one or more functionalities on said remote mobile device, comprising:
providing a client application on said remote mobile device;
sending an authentication code in combination with one or more commands to said client application on said remote mobile device;
receiving said authentication code with said one or more commands by said client application on said remote mobile device;
comparing said received authentication code with a predefined code stored on said remote mobile device by said client application to find a match;
executing said one or more commands by said client application on finding said match, wherein said one or more commands comprise instructions to induce said one or more functionalities on said remote mobile device; and
inducing said one or more functionalities on said remote mobile device by said client application on said execution of said one or more commands.

2. The method of claim 1, further comprising sending one or more parameters with said one or more commands to said client application on said remote mobile device, wherein said client application induces said one or more functionalities on said remote mobile device using said parameters.

3. The method of claim 1, wherein said one or more functionalities comprise performing a playback of a media file and simultaneously performing a recording operation by said remote mobile device.

4. The method of claim 1, wherein said one or more functionalities comprise retrieving information from said remote mobile device, wherein said information comprises geographical location of said remote mobile device, call logs, media files stored on said remote mobile device, and information of contacts stored on said remote mobile device.

5. The method of claim 1, wherein said authentication code with said one or more commands and parameters is sent to said client application on said remote mobile device using a short message service message.

6. The method of claim 1, wherein said one or more functionalities comprise modifying settings of said remote mobile device, wherein said modification of said settings comprises one or more of:
enabling or disabling a global positioning system on said remote mobile device;
adjusting volume of a ringer associated with a media file stored in said remote mobile device;
inducing mechanical vibrations on a body of said remote mobile device for a predefined event;
locking accessibility of said remote mobile device; and
disconnecting said remote mobile device from external waves.

7. The method of claim 1, wherein said one or more functionalities comprise invoking an operation on said remote mobile device, wherein said operation comprises forwarding messages to one or more second remote mobile devices based on instructions obtained from said commands.

8. The method of claim 1, wherein said one or more functionalities comprise invoking an operation on said remote mobile device, wherein said operation comprises capturing and storing media content for a predetermined period of time on said remote mobile device.

9. The method of claim 1, wherein said one or more functionalities comprise invoking an operation on said remote mobile device, wherein said operation comprises placing a call to one or more second remote mobile devices based on instructions obtained from said commands.

10. The method of claim 1, wherein said one or more functionalities comprise invoking a continuous operation on said remote mobile device, wherein said continuous operation comprises retrieving incoming messages, outgoing messages, and call records from said remote mobile device on a real time basis.

11. A system for establishing communication with a remote mobile device and inducing one or more functionalities on said remote mobile device, comprising:
a client application comprising:
a retrieval module that receives an authentication code with one or more commands and parameters;
a comparison module that compares said received authentication code with a predefined code stored on said remote mobile device to find a match;
an execution module that executes said one or more commands on finding said match, wherein said one or more commands comprise instructions to induce said one or more functionalities on said remote mobile device; and
a functionality control module that induces said one or more functionalities on said remote mobile device using said parameters.

12. The system of claim 11, wherein said functionality control module performs a playback of a media file and simultaneously performs a recording operation on said remote mobile device based on said one or more commands and parameters.

13. The system of claim 11, wherein said functionality control module retrieves information from said remote mobile device based on said one or more commands and parameters, wherein said information comprises geographical location of said remote mobile device, call logs, media files stored on said remote mobile device, and information of contacts stored on said remote mobile device, and wherein said retrieved information is sent to one of a controlling communication device and one or more second remote mobile devices.

14. The system of claim 11, wherein said authentication code with said one or more commands and parameters is sent to said client application on said remote mobile device using a short message service message.

15. The system of claim 11, wherein said functionality control module modifies settings of said remote mobile device based on said one or more commands and parameters, wherein said modification of said settings comprises one or more of:
enabling or disabling a global positioning system on said remote mobile device;
adjusting volume of a ringer associated with a media file stored in said remote mobile device;
inducing mechanical vibrations on a body of said remote mobile device for a predefined event;
locking accessibility of said remote mobile device; and
disconnecting said remote mobile device from external waves.

16. The system of claim 11, wherein said functionality control module invokes an operation on said remote mobile device based on said one or more commands and parameters, wherein said operation comprises forwarding messages to one or more second remote mobile devices based on instructions obtained from said commands.

17. The system of claim 11, wherein said functionality control module invokes an operation on said remote mobile device based on said one or more commands and parameters, wherein said operation comprises capturing and storing media content for a predetermined period of time on said remote mobile device.

18. The system of claim 11, wherein said functionality control module invokes an operation on said remote mobile device, wherein said operation comprises placing a call to one or more second remote mobile devices based on instructions obtained from said commands.

19. The system of claim 11, wherein said functionality control module invokes a continuous operation on said remote mobile device based on said one or more commands and parameters, wherein said continuous operation comprises retrieving incoming, outgoing messages, and call records from said remote mobile device on a real time basis.

20. A computer program product comprising computer executable instructions embodied in a computer readable storage medium, wherein said computer program product comprises:
a first computer parsable program code for providing a client application on a remote mobile device;
a second computer parsable program code for receiving an authentication code in combination with one or more commands and parameters by said client application on said remote mobile device;
a third computer parsable program code for comparing said received authentication code with a predefined code stored on said remote mobile device to find a match;
a fourth computer parsable program code for executing said one or more commands on finding said match, wherein said one or more commands comprise instructions to induce one or more functionalities on said remote mobile device; and
a fifth computer parsable program code for inducing said one or more functionalities on said remote mobile device using said parameters.
